(19) United States
(12) Patent Application Publication
(10) Pub. No.: US 2024/0078939 A1
(43) Pub. Date: Mar. 7, 2024

(54) WEARABLE MESSAGE DISPLAY DEVICE

(71) Applicant: Dudley O. Zinke, Cincinnati, OH (US)

(72) Inventor: Dudley O. Zinke, Cincinnati, OH (US)

(21) Appl. No.: 17/901,259

(22) Filed: Sep. 1, 2022

(51) Int. Cl. G09F 21/02; G06F 3/147; G09G 3/20

(52) U.S. Cl. CPC G09F 21/02; G06F 3/147; G09G 3/20

(57) ABSTRACT

A wearable message display device for displaying a customizable message from one's person includes a panel having a top end, a bottom end, a front face, a back face, a first lateral side, and a second lateral side. A display screen is mounted on and faces away from the front face of the panel. The display screen is programmable to selectively display a message. A harness is attached to and extends between the top end of the panel, the first lateral side, and the second lateral side of the panel. The harness extends around the back face of the panel. A controller is operationally coupled to the display screen and includes an input for entering the message to be displayed on the display screen.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wearable display devices and more particularly pertains to a new wearable display devices for displaying a customizable message from one's person.

### (2) Description of Related Art Including Information Disclosed Under 37 CFR 1.97 and 1.98

The prior art relates to wearable display devices which utilize electronic display screens for displaying customizable or moving imagery on a user's person. However, the prior art does not disclose an upper body garment which is programmable by a remote device for displaying varying text messages on the garment.

### BRIEF SUMMARY OF THE INVENTION

An embodiment of the disclosure meets the needs presented above by generally comprising a panel having a top end, a bottom end, a front face, a back face, a first lateral side, and a second lateral side. A display screen is mounted on and faces away from the front face of the panel. The display screen is programmable to selectively display a message. A harness is attached to and extends between the top end of the panel, the first lateral side, and the second lateral side of the panel. The harness extends around the back face of the panel. A controller is operationally coupled to the display screen and includes an input for entering the message to be displayed on the display screen.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a wearable message display device according to an embodiment of the disclosure.

FIG. 2 is a side view of a panel and a harness of an embodiment of the disclosure.

FIG. 3 is a front view of a controller of an embodiment of the disclosure.

FIG. 4 is an in-use view of an embodiment of the disclosure with a display screen facing forwardly from a user.

FIG. 5 is an in-use view of an embodiment of the disclosure with a display screen facing rearwardly from a user.

### DETAILED DESCRIPTION OF THE INVENTION

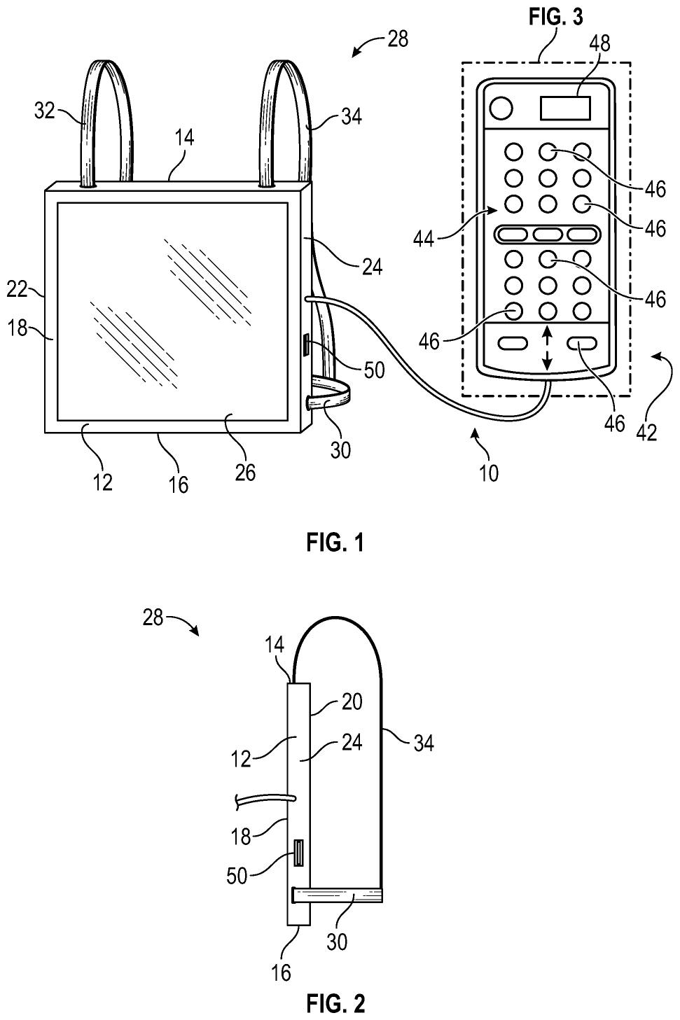

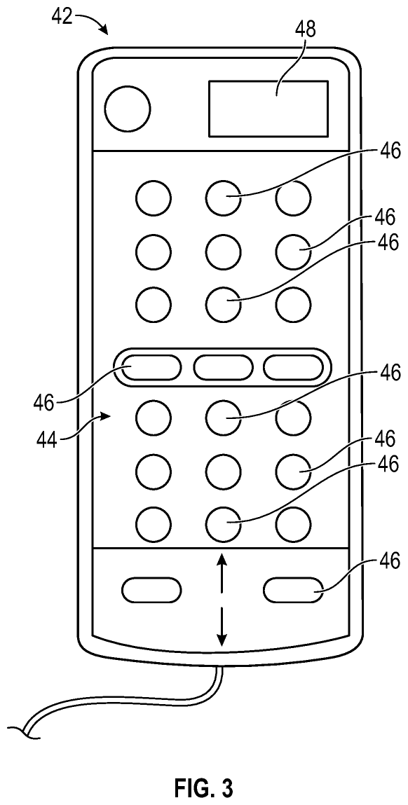

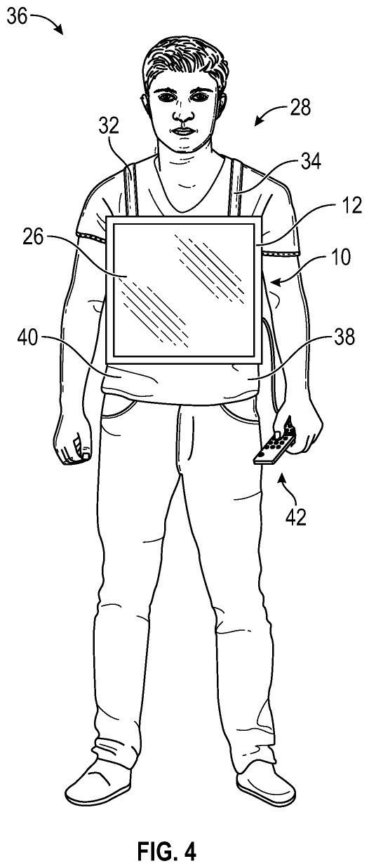

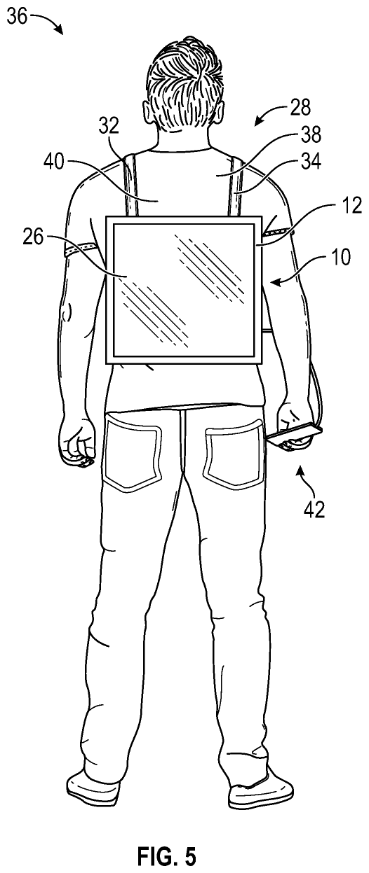

With reference now to the drawings, and in particular to FIGS. 1 through 5 thereof, a new wearable display devices embodying the principles and concepts of an embodiment of the disclosure and generally designated by the reference numeral 10 will be described.

As best illustrated in FIGS. 1 through 5, the wearable message display device 10 generally comprises a panel 12 having a top end 14, a bottom end 16, a front face 18, a back face 20, a first lateral side 22, and a second lateral side 24. A display screen 26 is mounted on and faces away from the front face 18 of the panel 12 and is programmable to selectively display a message. A “message” as used in this detailed description and the claims includes any visual indicia which communicates an idea and may be textual, symbolic, graphic or the like. A harness 28 is attached to and extends between the top end 14 of the panel 12, the first lateral side 22, and the second lateral side 24 of the panel 12. The harness 28 extends around the back face 20 of the panel 12 so that when a user 36 wears the harness 28, the display screen 26 faces away from the user 36. The panel 12 and the display screen 26 may be flexible such that the panel 12 and the display screen 26 at least partially conform to a surface 40 of a torso 38 of the user 36 when worn.

The harness 28 comprises a waist strap 30, a first shoulder strap 32, and a second shoulder strap 34. The waist strap 30 is attached to and extends between the first lateral side 22 and the second lateral side 24 of the panel 12. The first shoulder strap 32 is attached to and extends between the top end 14 of the panel 12 adjacent the first lateral side 22 of the panel 12 and the waist strap 30, and the second shoulder strap 34 is attached to and extends between the top end 14 of the panel 12 adjacent the second lateral side 24 of the panel 12 and the waist strap 30.

A controller 42 is operationally coupled to the display screen 26 and includes an input 44 for entering the message to be displayed on the display screen 26. The input 44 comprises a plurality of buttons 46 but may be a touch screen or the like. The controller 42 includes a message display 48 for showing the message to be displayed on the display screen 26. The controller 42 may be electrically coupled to the display screen 26 or communicate wirelessly. In a first embodiment, a power source is electrically coupled to the controller 42 and the display screen 26 and comprises a battery mounted in a housing of the controller 42. The panel 12 may have a charging port 50 in the first embodiment for charging the power source. In a second embodiment, a first power source is electrically coupled to the controller 42, and a second power source is electrically coupled to the display screen 26. In the second embodiment, the panel 12 may have a charging port 50 for charging the second power source.

In use, the user 36 wears the harness 28 on the torso 38 of the user 36 so that the display screen 26 faces away from the user 36. The user 36 may wear the harness 28 with the display screen 26 facing forwardly from the user 36 or with the display screen 26 facing rearwardly from the user 36. The user 36 enters the message via the input 44 of the controller 42 and may view the message on the message display 48 of the controller 42 before sending the message to the display screen 26. Then the user 36 sends the message via the input 44 of the controller 42 to the display screen 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wearable message display device comprising:
a panel having a top end, a bottom end, a front face, a back face, a first lateral side, and a second lateral side;
a display screen being mounted on and facing away from the front face of the panel, the display screen being programmable to selectively display a message;
a harness being attached to and extending between the top end of the panel, the first lateral side, and the second lateral side of the panel, the harness extending around the back face of the panel; and
a controller being operationally coupled to the display screen, the controller including an input for entering the message to be displayed on the display screen.

2. The device of claim 1, further comprising a power source being electrically coupled to the controller.

3. The device of claim 2, further comprising the display screen being electrically coupled to the power source and the controller.

4. The device of claim 2, further comprising the power source being a first power source, the display screen being wirelessly operatively coupled to the controller and electrically coupled to a second power source.

5. The device of claim 1, further comprising the harness comprising a waist strap, a first shoulder strap, and a second shoulder strap, the waist strap being attached to and extending between the first lateral side and the second lateral side of the panel, the first shoulder strap being attached to and extending between the top end of the panel adjacent the first lateral side of the panel and the waist strap, the second shoulder strap being attached to and extending between the top end of the panel adjacent the second lateral side of the panel and the waist strap.

6. The device of claim 1, further comprising the input of the controller comprising a plurality of buttons.

7. The device of claim 1, further comprising the input of the controller comprising a touch screen.

8. The device of claim 1, further comprising the controller including a message display, the message display showing the message to be displayed on the display screen.

9. The device of claim 1, further comprising the panel and the display screen being flexibly deformable.

10. A wearable message display device comprising:
a panel having a top end, a bottom end, a front face, a back face, a first lateral side, and a second lateral side;
a display screen being mounted on and facing away from the front face of the panel, the display screen being programmable to selectively display a message;
a harness being attached to and extending between the top end of the panel, the first lateral side, and the second lateral side of the panel, the harness extending around the back face of the panel, the harness comprising a waist strap, a first shoulder strap, and a second shoulder strap, the waist strap being attached to and extending between the first lateral side and the second lateral side of the panel, the first shoulder strap being attached to and extending between the top end of the panel adjacent the first lateral side of the panel and the waist strap, the second shoulder strap being attached to and extending between the top end of the panel adjacent the second lateral side of the panel and the waist strap;
a controller being operationally coupled to the display screen, the controller including an input for entering the message to be displayed on the display screen, the input comprising a plurality of buttons, the controller including a message display, the message display showing the message to be displayed on the display screen; and
a power source being electrically coupled to the controller and the display screen, the power source comprising a battery mounted in a housing of the controller.
